(19) United States
(12) Patent Application Publication
(10) Pub. No.: US 2026/0080275 A1
(43) Pub. Date: Mar. 19, 2026

(54) CONTEXT-BASED CURATION OF USER DEVICE CONTENT

(71) Applicant: International Business Machines Corporation, Armonk, NY (US)

(72) Inventors: Alecio Pedro Delazari Binotto, Munich (DE); Fernando Luiz Koch, Palm Beach Gardens, FL (US); Francis Powlesland, Munich (DE)

(21) Appl. No.: 18/890,539

(22) Filed: Sep. 19, 2024

(51) Int. Cl. G06N 5/025

(52) U.S. Cl. CPC G06N 5/025

(57) ABSTRACT

A method, according to one approach, includes obtaining first contextual data collected by a plurality of sensors and performing machine learning techniques to extract features from the first contextual data. User device content is curated based on the extracted features and preferences of a first user. The method further includes collaboratively filtering-out a first portion of the curated user device content based on a second user, and causing a second portion of the curated user device content to be provided to a user device of the first user. A computer program product, according to another approach, includes one or more computer-readable storage media, and program instructions stored on the one or more storage media to perform any combination of features of the foregoing methodology.

### BACKGROUND

The present invention relates to artificial intelligence (AI), and more specifically, this invention relates to context-aware generative models.

Context-aware generative models enable personalized and adaptive content creation that adjusts content generation parameters in dynamic environments. Mobile generation AI serves as an architectural solution for deploying large generative models, with the inference engine situated on graphics processing unit (GPU)-based computer resources integrated into mobile environments such as planes, ships, cars, and mobile devices. These environments leverage multiple different sensors to infer current context and utilize large generative models to forecast future context. Conventional content generation models have been unable to meet a demand for enabling the real-time updating of content generation parameters to adapt to current or anticipated changes in context, accommodating occasional constraints in computing resources, and relevant contextual scenarios.

### SUMMARY

A method, according to one approach, includes obtaining first contextual data collected by a plurality of sensors and performing machine learning techniques to extract features from the first contextual data. User device content is curated based on the extracted features and preferences of a first user. The method further includes collaboratively filtering-out a first portion of the curated user device content based on a second user, and causing a second portion of the curated user device content to be provided to a user device of the first user.

A computer program product, according to another approach, includes one or more computer-readable storage media, and program instructions stored on the one or more storage media to perform any combination of features of the foregoing methodology.

A computer system, according to another approach, includes a processor set, one or more computer-readable storage media, and program instructions stored on the one or more storage media to cause the processor set to perform any combination of features of the foregoing methodology.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a flowchart of a method, in accordance with one approach of the present invention.

FIG. 3 is a system that includes infrastructure for curating user device content, in accordance with one approach of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for context-based curation of user device content.

In one general approach, a method includes obtaining first contextual data collected by a plurality of sensors and performing machine learning techniques to extract features from the first contextual data. User device content is curated based on the extracted features and preferences of a first user. The method further includes collaboratively filtering-out a first portion of the curated user device content based on a second user, and causing a second portion of the curated user device content to be provided to a user device of the first user.

A technical effect of filtering-out the first portion of the curated user device content based on the second user includes reducing an amount of the user device content that is processed, transmitted and offered to user devices. More specifically, a technical effect of using various operations of the method include ensuing that a sufficient but not relatively extensive amount of user device content is curated and provided to a user device. At least some curated device content (the first portion of the curated user device content) is filtered-out of the curated user device content to ensure this amount of user device content. As a result of this filtering, network traffic potential and user device processing that would otherwise be consumed processing the first portion of the curated user device content is preserved.

The sensors may include at least some mobile sensors where the features extracted from the first contextual data may include passenger location, movement patterns, ambient noise levels, vehicle speed, and environmental conditions.

Obtaining contextual data from a plurality of different types of sensors has a technical effect of diversifying the data that is ultimately analyzed in the techniques described herein. Furthermore, use of at least some mobile sensors in these sensors has a technical effect of ensuring that the contextual data remains accurate despite the location of the user changing. It should be noted that without some of the sensors being mobile sensors, obtaining the contextual information would incur an additional processing load as sensors readings would have to be transmitted across a network as the location of the user changes.

The environmental conditions may include a current ambient temperature of a transportation medium that the first user is located on, a current noise level that the first user is subjected to while located on the transportation medium, a current type of scenery view that the first user has while on the transportation medium, and a strength of network signal that the user device of the first user is connected to.

Considering different environmental conditions in a determination of what curated content to provide to a user device has a technical effect of ensuring that content that does not correlate with current environmental conditions is filtered out before being transmitted to the first user device. This reduces network traffic in a network that the first user device is connected to in order to receive the user device content. More specifically, consideration of different environmental conditions has a technical effect of establishing content that should not be processed, e.g., content based on environmental conditions that are not present in an environment of the user, and therefore, a processing load that would otherwise be performed by a processing circuit that is performing operations of the method is ultimately reduced.

The features extracted from the first contextual data may include first environmental conditions and, the machine learning techniques performed may include application of collaborative filtering and application of contextual embedding models. The method may further include obtaining second contextual data collected by the plurality of sensors, and performing the machine learning techniques to extract features from the second contextual data, where the features extracted from the second contextual data detail second environmental conditions that are different than the first environmental conditions. In response to a determination that the second environmental conditions have less than a predetermined degree of similarity with the first environmental conditions, updated user device content may be curated based on the second environmental conditions, a first portion of the updated curated user device content may be collaboratively filtered-out, and a second portion of the updated curated user device content may be caused to be provided to the user device of the first user.

A technical effect of using collaborative filtering and application contextual embedding models includes reducing an amount of the user device content that is processed by referencing determinations previously performed for other users. Furthermore, a technical effect of obtaining additional contextual data includes ensuring that as conditions of an environment in which the user device is located changes, the curated user device content also changes to reflect the changing conditions.

Curating user device content based on the extracted features and preferences of the first user may include applying a rule-based inference to analyze the extracted features to identify patterns that represent preferences of the first user and preferences of the second user, and parsing available content libraries to identify the user device content, where the user device content has characteristics that match portions of the identified patterns. Curating user device content based on the extracted features and preferences of the first user may further include ranking portions of the user device content based on the preferences of the first user, where the collaborative filtering incorporates the rankings.

A technical effect of using rule-based inferencing to analyze the extract features includes using results of the analysis, e.g., the identified patterns, to determine a sub-portion of the available content libraries to further process. Ranking these portions further enables this refinement and reduces the amount of computer transmission operations and processing that would otherwise be performed in the event that the entire content library was provided to the user device of the first user.

The second user may be a user that is determined to have previously experienced environmental conditions of the extracted features while using a second user device, and the second user may be determined, based on cosine similarity, to have preferences with at least a predetermined degree of similarity with the preferences of the first user.

Use of cosine similarity in the determination that the second user has previously experienced the environmental conditions of the extracted features while using a second user device has a technical effect of sourcing previously performed determinations for reducing an amount of processing that is involved in performing further determinations. This preserves processing resources of a processing device (such as a computer) that is performing operations of the method.

The method may further include applying rule-based inferencing to identify a first machine learning algorithm, causing the first machine learning algorithm to train a model to use training contextual data to extract features from the training contextual data, and causing the trained model to determine the preferences of the first user.

A technical effect of causing a machine learning algorithm to train a model used to determine the preferences of the first user includes mitigation of processing delays and errors that would otherwise be introduced in the process of a human attempting to determine such preferences.

The collaborative filtering-out of the first portion of the curated user device content based on the second user may include causing a rule-based inference and/or large generative model to implement a recommendation engine that utilizes the trained model to generates and provides an indication of the second portion of the curated user device content.

A technical effect of filtering-out the first portion of the curated user device content based on the second user includes reducing an amount of the user device content that is processed, transmitted and offered to user devices.

The method may further include obtaining feedback from the user device of the first user (where the feedback includes selections made by the first user on the user device), and using the feedback to update the trained model to refine an extraction accuracy of the trained model. Using feedback to refine an accuracy of the trained model has a technical effect of iteratively improving the portions of data that are ultimately provided to user devices for users to view. Furthermore, by refining an accuracy of the trained model, curated user device content that would otherwise be unnecessarily processed is not transmitted to and processed by the user device. This preserves processing resources and ultimately reduces an amount of computations that are performed in each iteration of the method.

In another general approach, a computer program product includes one or more computer-readable storage media, and program instructions stored on the one or more storage media to perform any combination of features of the foregoing methodology. Similar technical effects are obtained.

In another general approach, a computer system includes a processor set, one or more computer-readable storage media, and program instructions stored on the one or more storage media to cause the processor set to perform any combination of features of the foregoing methodology. Similar technical effects are obtained.

In another general approach, a method includes obtaining first contextual data collected by a plurality of mobile sensors and performing machine learning techniques to extract features from the first contextual data. User device content is curated based on the extracted features and preferences of a first user. The method further includes collaboratively filtering-out a first portion of the curated user device content based on a second user, and causing a second portion of the curated user device content to be provided to a user device of the first user. The features extracted from the first contextual data may include any combination of passenger location, movement patterns, ambient noise levels, vehicle speed, and environmental conditions.

A technical effect of filtering-out the first portion of the curated user device content based on the second user includes reducing an amount of the user device content that is processed, transmitted and offered to user devices. More specifically, a technical effect of using various operations of the method include ensuing that a sufficient but not relatively extensive amount of user device content is curated and provided to a user device. At least some curated device content (the first portion of the curated user device content) is filtered-out of the curated user device content to ensure this amount of user device content. As a result of this filtering, network traffic potential and user device processing that would otherwise be consumed processing the first portion of the curated user device content is preserved.

In another general approach, a method includes obtaining first contextual data collected by a plurality of mobile sensors and performing machine learning techniques to extract features from the first contextual data. User device content is curated based on the extracted features and preferences of a first user. The method further includes collaboratively filtering-out a first portion of the curated user device content based on a second user, and causing a second portion of the curated user device content to be provided to a user device of the first user. The environmental conditions may include a current ambient temperature of a transportation medium that the first user is located on, a current noise level that the first user is subjected to while located on the transportation medium, a current type of scenery view that the first user has while on the transportation medium, and a strength of network signal that the user device of the first user is connected to.

A technical effect of filtering-out the first portion of the curated user device content based on the second user includes reducing an amount of the user device content that is processed, transmitted and offered to user devices. More specifically, a technical effect of using various operations of the method include ensuing that a sufficient but not relatively extensive amount of user device content is curated and provided to a user device. At least some curated device content (the first portion of the curated user device content) is filtered-out of the curated user device content to ensure this amount of user device content. As a result of this filtering, network traffic potential and user device processing that would otherwise be consumed processing the first portion of the curated user device content is preserved.

In one use case approach, a context-aware generative model may be deployed in a high-speed train (or any other passenger transport medium) equipped with a mobile generative AI environment designed to provide on-demand content to passengers during their journey. Within this use case, a method includes obtaining first contextual data collected by a plurality of mobile sensors and performing machine learning techniques to extract features from the first contextual data. Such a train may be equipped with various sensors, including cameras, microphones, temperature sensors, and motion sensors, strategically placed throughout the cabins of the train. The sensors may be configured to collect data on passenger movements, environmental conditions (such as temperature, noise level, and lighting), and demographic information. User device content is curated based on the extracted features and preferences of a first user on the train. The method further includes collaboratively filtering-out a first portion of the curated user device content based on a second user, and causing a second portion of the curated user device content to be provided to a user device of the first user.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as context-based curation code of block 150 for context-based curation of user device content. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

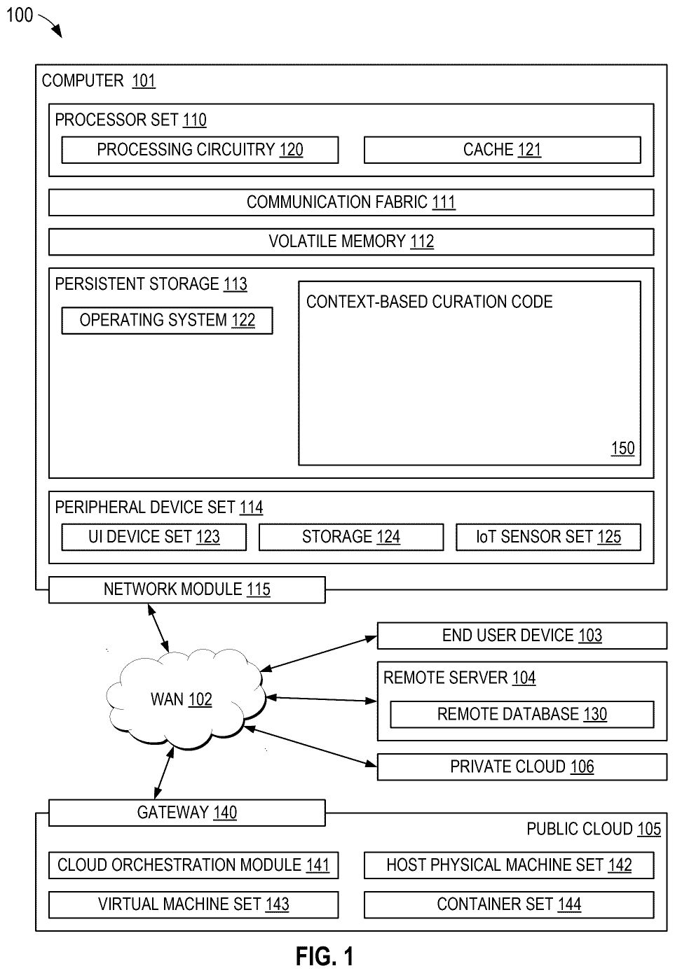

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned elsewhere above, context-aware generative models enable personalized and adaptive content creation that adjusts content generation parameters in dynamic environments. Mobile generation artificial intelligence (AI) serves as an architectural solution for deploying large generative models, with the inference engine situated on graphics processing unit (GPU)-based computer resources integrated into mobile environments such as planes, ships, cars, and mobile devices. These environments leverage multiple different sensors to infer current context and utilize large generative models to forecast future context. Conventional content generation models are unable to meet a demand for enabling the real-time updating of content generation parameters to adapt to current or anticipated changes in context, accommodating occasional constraints in computing resources, and relevant contextual scenarios.

Conventional content generation models are unable to meet the demand for enabling the factors described above for a number of reasons. For example, a first of these factors is based on the conventional models being unable to apply collaborative filtering techniques to optimize content generation in multi-modal mobile environments. Furthermore, these context-aware generative models cannot be utilized to forecast future context in dynamic environments such as planes, ships, and cars. These conventional computing resources are also unable to cause onboarded vehicles be efficiently utilized to cater to on demand content generation for multiple users and cause content generation parameters be updated in real-time to adapt to changing contextual scenarios. Another issue that context-aware generative models struggle with is adapting content generation to accommodate occasional constraints in computing resources.

In order to address the deficiencies of the conventional models described above, various approaches described herein introduce techniques to integrate sensor data, context-aware generative models, and collaborative filtering techniques to refine content generation in multi-modal mobile generative AI environments. These techniques aim to enhance passenger experiences in some use cases, as well as ensure optimal content delivery regardless of changing conditions. To enable this delivery, these models leverage local generative AI facilities onboard vehicles to cater to on-demand content generation for multiple users. These approaches enable the creation of a solution that seamlessly integrates sensor data analysis, context-aware generative models, and collaborative filtering techniques to dynamically adapt content generation in real-time, providing passengers of transportation mediums, e.g., such as the train described below, with a personalized and enriching experience throughout their journey.

In one use case of the techniques described herein, a context-aware generative model may be deployed in a high-speed train equipped with a mobile generative AI environment designed to provide on-demand content to passengers during their journey. Such a train may be equipped with various sensors, including cameras, microphones, temperature sensors, and motion sensors, strategically placed throughout the cabins of the train. The sensors may be configured to collect data on passenger movements, environmental conditions (such as temperature, noise level, and lighting), and demographic information. Context-aware generative models analyze the sensor data in real-time to understand the current environment and passenger preferences. Furthermore, dynamic adaption of content generation to changing conditions is enabled based on real-time data analysis. For example, in response to a determination that the train is passing through a tunnel where connectivity is limited, infrastructure associated with these techniques may be caused, e.g., instructed, to switch to locally stored content or content that does not use a relatively strong internet connection. These techniques may then additionally and/or alternatively apply collaborative filtering techniques to identify common preferences among passengers or groups of passengers. That is, in response to a determination that a group of passengers consistently interacts positively with certain types of content, such as documentaries or language learning modules, recommendations of similar content may be provided to user devices of other passengers determined to have similar preferences. In order to ensure that content generation strategies maintain accuracy despite changing modal environments and preferences of users of user devices, the approaches described herein focus on leveraging rule-based inference and large AI models to infer passenger preferences and environmental context from sensor data, thereby enabling dynamic adaptation of content generation strategies in real-time within mobile generative AI environments.

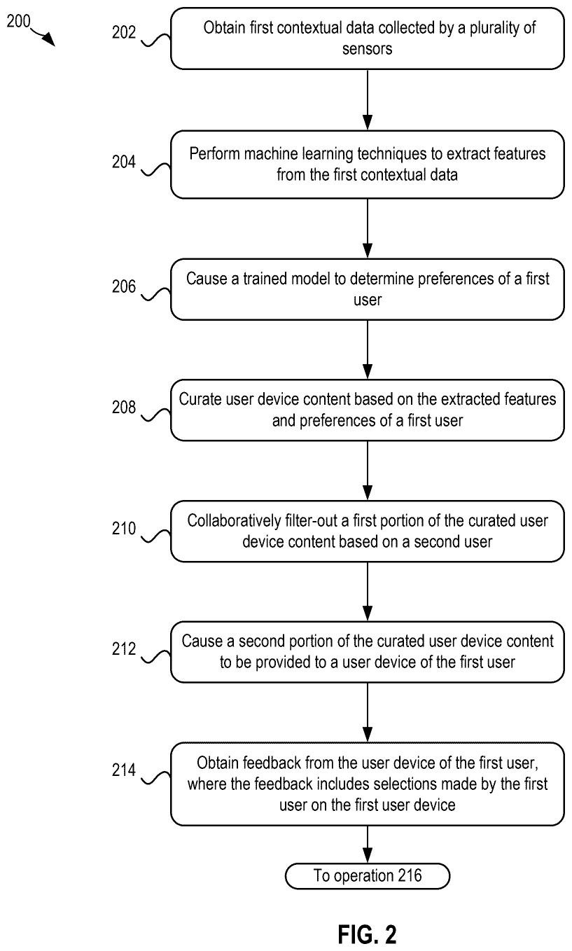

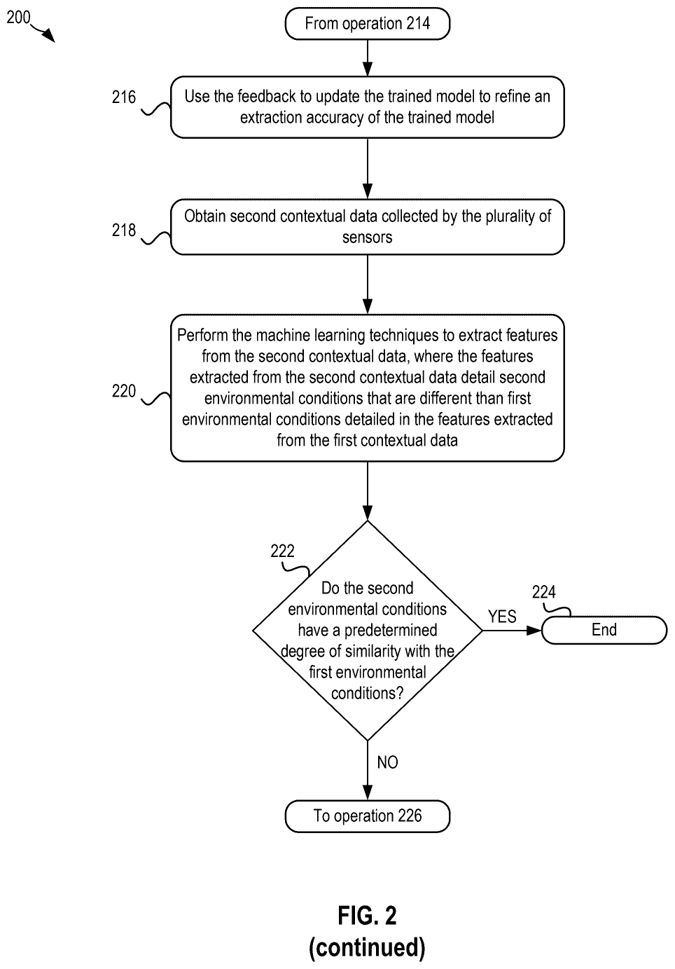

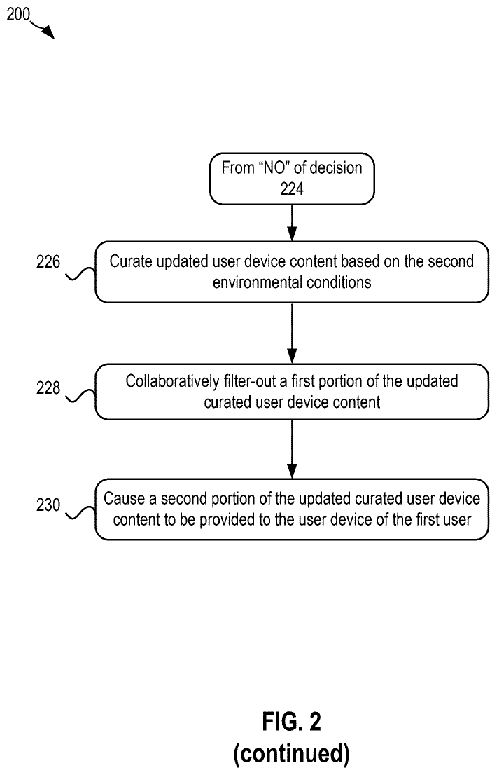

Now referring to FIG. 2, a flowchart of a method 200 is shown according to one approach. The method 200 may be performed in accordance with aspects of the present invention in any of the environments depicted in FIGS. 1-3, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that various operations described herein refer to the processing and analysis of user data, e.g., such as user preferences. This consideration and use of user data is preferably only performed subsequent to gaining expressed permission from the users to do so, e.g., such as via an opt-in clause which the user is free to thereafter opt-out of in response to the user changing their mind. Furthermore, it may be prefaced that some of the approaches described herein use sensors that are mobile sensors, e.g., sensors that are installed within a transport medium such as a train, plane, automobile, etc., based on the content of the techniques described herein being made available to users using user devices while traveling via these transport mediums. These use-cases are detailed for illustritive purposes, and in some other approaches, the techniques described herein may additionally and/or alternatively be deployed in any environment in which a user is using a user device to view content.

Various operations described below detail a first portion of method 200 that include a context-aware generative model management in mobile generative AI. This first portion includes processes to collect and preprocess sensor data able to classify and filter extract relevant features, such as passenger location, movement patterns, ambient noise levels, vehicle speed, and environmental conditions. Although steps of the first portion may be performed in different orders, depending on the approach, a first step of the first portion of method 200 is described below and includes performing contextual analysis and feature extraction steps.

Operation 202 includes obtaining first contextual data collected by a plurality of sensors. As indicated elsewhere above, in some approaches, the sensors may include at least some the sensors include at least some mobile sensors, in some approaches. These mobile sensors may include sensors of a component that is configured to change the location of the sensor without changing the location of a user that the sensor is observing, e.g., a drone, in some approaches, while in some other approaches, the sensors may be integrated into a transport medium that is configured to allow a user to ride on the transport medium, e.g., a microphone in a car, a camera on a train, a temperature sensors on a plane, etc. The sensors may, in some approaches, include cameras, microphones, a global positioning systems (GPS), an accelerometers, environmental sensors, etc. The plurality of sensors may additionally and/or alternatively include other sensors which may not be mobile sensors. For example, these sensors may include sensors that observe a first user as the first user travels to and/or from the transport medium that includes one or more of the mobile sensors, sensors that document environmental conditions that the transport medium traverses, sensors coupled to the first user, etc.

Obtaining contextual data from a plurality of different types of sensors has a technical effect of diversifying the data that is ultimately analyzed in the techniques described herein. Furthermore, use of at least some mobile sensors in these sensors has a technical effect of ensuring that the contextual data remains accurate despite the location of the user changing. It should be noted that without some of the sensors being mobile sensors, obtaining the contextual information would incur an additional processing load as sensors readings would have to be transmitted across a network as the location of the user changes.

In some approaches, the first contextual data is received by a processing circuit that is configured to perform the operations of method 200. In some other approaches, the first contextual data obtained as a result of a query being issued to one or more of the sensors of the plurality of sensors.

Operation 204 includes performing machine learning techniques to extract features from the first contextual data. For context, the features extracted from the first contextual data include information that details an environment that a user may be subjected to at one or more predetermined periods of time, e.g., a past period of time, a current time, a future period of time as based on an estimation, etc. In some approaches, the features extracted from the first contextual data include passenger location, which may include, e.g., a GPS location of a passenger that is the user mentioned above, a location of the passenger within a transport medium, an anticipated location of the passenger at a future period of time (such as an anticipated destination of the transport medium), etc. In some other approaches, the features extracted from the first contextual data may additionally and/or alternatively include movement patterns, e.g., patterns of movement of a transport medium that the user has historically ridden in and/or driven, bus routes, train routes, traffic patterns, etc. The features extracted from the first contextual data may additionally and/or alternatively include ambient noise levels, e.g., noise that the user is subject to within a transport medium, noise that the user is estimated to be subject to based on an anticipated route of the user while riding on a transport medium, nose that the user has been subjected to within a predetermined sampling period, etc. A vehicle speed, such as a vehicle that the user is rising in and/or driving is another feature that may be extracted from the first contextual data, in some approaches.

Environmental conditions are yet another feature that may be extracted from the first contextual data. The environmental conditions, in some approaches, include a current ambient temperature of a transportation medium that the first user is located on. Such temperature information may be based on and/or include forecasted weather conditions, natural disaster information, light conditions, etc. Furthermore, in some approaches, the environmental conditions, in some approaches, may additionally and/or alternatively include a current noise level that the first user is subjected to while located on the transportation medium. A current type of scenery view that the first user has while on the transportation medium is another type of the environmental conditions. For example, scenic views of a mountain range may be associated with a type of scenic view that the user is estimated to enjoy, and therefore would like to view rather than viewing a user device. A strength of network signal that the user device of the first user is connected to is another type of the environmental conditions, e.g., relatively strong internet signal, relatively weak signal, no signal based on a loss of connection while the transport medium is traveling through a tunnel, etc.

In order to perform machine learning techniques to extract features from the first contextual data, in some approaches, method 200 includes implementing rule-based inferencing and/or machine learning algorithms to interpret the first contextual data. The rule-based inferencing and/or machine learning algorithms may be of a type that would become apparent to one of ordinary skill in the art after reading the descriptions herein. In some preferred approaches, the rule-based inferencing and/or machine learning algorithms are configured, e.g., trained using a training set of data until a predetermined threshold of accuracy is met, to derive contextual information, such as passenger activities, preferences, and/or environmental context from the first contextual data. For example, these preferences may include types of content that the first user reports to enjoy watching when different extracted features are present. For example, in some approaches, a determination may be made that audio-based content is enjoyed by the user and/or content that the user is likely to select while a transport medium that the user is traveling on has scenic views of a mountain range.

In some approaches, the machine learning techniques performed include application of collaborative filtering and application of contextual embedding models to extract meaningful features from the contextual data. These application(s) result in a set of contextual features being obtained that capture a diverse aspects of a mobile environment that the first user is located in while consuming content on a user device. For example, as detailed above, these contextual features may include, e.g., passenger behavior, preferences, situational context, etc.

A second step of the first portion of method 200 is described below and includes performing dynamic model selection and loading steps. In some approaches, these steps include implementing a rule-based inference for model management system capable of dynamically selecting and loading relevant generative AI models based on the inferred context and/or determined user demands. These user demands may, in some approaches, be determined from, e.g., a query, evaluation of the obtained first contextual data, etc.

Rule-based inferencing of a type that would become apparent to one of ordinary skill in the art after reading the descriptions herein may be implemented to select generative models to be applied for the current user demands and context. In some approaches, the generative models may be based on a preconfigured set of generative AI models tailored to specific content genres, styles, and/or formats.

In some approaches, subsequent to implementation of the rule-based inferencing, method 200 includes executing a predetermined algorithm configured to cause a model loading mechanism to load or unload AI models based on changing demand patterns.

A third step of the first portion of method 200, in some preferred approaches, includes operations performed to enable real-time content generation and delivery. In some approaches, these operations include implementing a rule-based inference to integrate the selected generative AI models mentioned above with an inference engine to enable real-time content generation based on inferred context and user preferences, e.g., where the context and user preferences may be determined using the techniques described above for analyzing obtained contextual data. These user preferences may be further used, in some approaches, by implementing rule-based decision(s) with large generative model-based inferencing to implement content generation algorithms that prioritize relevant content types and styles based on individual user profiles and contextual cues. As will be described in further detail elsewhere herein, any content that is identified for a user device and/or as a candidate sample of content may be identified from a predetermined library of available content using the identification and analysis techniques described herein. The third step, may, in some approaches, additionally and/or alternatively include executing an algorithm configured to cause adaptive streaming between the identified content to optimize content delivery over limited bandwidth and/or intermittent network connectivity. In other words, in response to identifying candidate content that may be recommended to a user, in some approaches, method 200 includes anticipating (from the extracted features) locations at which network connectivity may be lost, and optionally downloading such content in the event that the candidate content becomes in demand at the anticipated locations.

A third step of the first portion of method 200, in some preferred approaches, includes operations configured to ensure that continuous learning and adaptation is incorporated into the models described herein. It should be noted that such learning and adaptation may occur as a result of consumption sessions of user device content, e.g., based on user feedback as will be described in further detail elsewhere herein (see operations 214-216). However, in some approaches, this learning and adaptation may additionally and/or alternatively occur in training sessions performed in order to ensure that the models used to obtain contextual data and extract features have at least a predetermined degree of accuracy before being deployed in use case environments.

In some approaches, the third step of the first portion of method 200 may include implementing rule-based inference feedback loops to capture user interactions and feedback during content consumption sessions. As mentioned above, these feedback loops may additionally and/or alternatively be implemented while training the models described herein, e.g., using a predetermined training set of data which may be monitored by a subject matter expert for a first subset of the training iterations before using a remainder majority portion of the training set of data. Reinforcement learning algorithms may additionally and/or alternatively be implemented to continuously learn and adapt content generation strategies based on user preferences and environmental dynamics to enact these accuracy improvements. In some other approaches, evaluations and/or A/B testing may additionally and/or alternatively be implemented to validate the effectiveness of the proposed methods and identify opportunities for further refinement (of respective accuracies of the models) and enhancement.

Various operations described below detail a second portion of method 200 that includes adaptive content curation in mobile generative AI. At a relatively high level, this portion of method 200 includes curating content based on both individual preferences and collective trends identified within the features extracted from the contextual data and/or and user interactions that are gathered to determine comprehensive insights into individual preferences and group dynamics. In some approaches, steps of the second portion of method 200 additionally and/or alternatively consider a dual approach to adaptive content curation in mobile generative AI that focuses on both individual user preferences and the collective trends observed through sensor data.

It should be noted that although steps of the second portion may be performed in different orders, depending on the approach, a first step of the second portion of method 200 is described below and includes performing data analysis. For example, operation 208 includes curating user device content based on the extracted features and preferences of a first user.

In some approaches, curation of the user device content may include applying a rule-based inference combined with machine learning algorithms to analyze the extracted features of the contextual data. More specifically, in some approaches, this analysis may be performed identify patterns and trends that represent both individual and collective preferences, e.g., both preferences of the first user and preferences of second users that are determined to have at some time had a previous degree of similarity with the first user (such as in similar environmental conditions). Application of a rule-based inference to extract actionable insights form the analysis that can influence content curation, e.g., such as popular topics, preferred formats, and/or emerging trends among passengers, may additionally and/or alternatively be performed to incorporate further analysis of the selection of user device content to potentially offer to a user device.

Filtering may be performed to filter-out a first portion of the curated user device content in order to establish a second portion of data that satisfies demands and/or preferences of the first user. It should be noted that such filtering also reduces an amount user device content that is processed, transmitted and offered to user devices. This reduces network traffic in a network that includes the user devices mentioned herein. For example, in some approaches, in a second step of the second portion of method 200, personalized content filtering may be performed. In order to stage such filtering, in some approaches, a rule-based inference may be applied to classify user profiles based on factors including, but in some approaches not limited to, past interactions, content consumption history, and/or inferred preferences through sensor data analysis. Furthermore, the curation may include parsing available content libraries to identify the user device content, where the user device content has characteristics that match portions of the identified patterns and/or trends mentioned elsewhere above. For example, in some approaches, an algorithm may be implemented for performing collaborative filtering and other recommendation algorithms may be used to sift through available content and identify items that match the individual profiles. Portions of the user device content may be ranked based on the preferences of the first user, in some approaches of curating the user device content. The collaborative filtering may then incorporate these rankings, e.g., a predetermined number of user device content having relatively highest priority rankings may be preserved in a second portion of the curated user device content, while the other user device content (a first portion of the curated user device content) may be filtered-out. In some approaches, rule-based inference combined with machine learning algorithms may be applied to rank the user device content based on a determined relevance to the first user's profile and/or an urgency or timeliness of the content (considering the current context and environmental factors).

A technical effect of using rule-based inferencing to analyze the extract features includes using results of the analysis, e.g., the identified patterns, to determine a sub-portion of the available content libraries to further process. Ranking these portions further enables this refinement and reduces the amount of computer transmission operations and processing that would otherwise be performed in the event that the entire content library was provided to the user device of the first user.

A third step of the second portion of method 200 may include steps based on collective content adaptation. For context, this adaptation may include steps that dynamically change the collection of content that is curated for the user device of the first user as factors (that may be used to curate the collection of content) change, e.g., user preferences change, environmental conditions change, etc. For example, in some approaches, a rule-based inference, which may be of a type that would become apparent to one of ordinary skill in the art after reading the descriptions herein, may be applied and eventually be supported by a ML model, to classify collective behavior and preferences to adapt the user device content being curated for user devices being used in group settings, such as shared displays in a transport medium. A rule-based inference and/or generative model-based methods may be applied to modify content parameters (such as language, complexity, and presentation style) to better suit the collective needs and preferences identified. Furthermore, an algorithm may be implemented to deliver content that has been adapted for multiple users, ensuring that the content remains engaging and relevant to a majority of users in the mobile environment (in group settings).

A fourth step of the second portion of method 200 may include steps based on contextual realignment and proactive curation. For example, these steps may include collecting feedback through direct user interactions and passive monitoring of content engagement levels. This data and/or other data collected via sensors onboard a transport medium may be used to continuously monitor the changing environmental and user context to anticipate needs or changes in content preferences. The adaptiveness of content curation may additionally and/or alternatively be achieved by applying a rule-based inference and/or large generative model-based methods to adjust content curation models in real-time based on anticipatory data, ensuring that content delivery remains aligned with current and anticipated conditions. Operation 212 includes causing a second portion of the curated user device content to be provided to the user device of the first user. In some approaches, an algorithm may be implemented to schedule and deliver the second portion of the curated user device content to the user device. This second portion of the curated user device content is content that survives the filtering, fits a current context of the first user, and also prepares the first user for upcoming changes, such as transitioning from a work-oriented environment to entertainment as a journey of a transport medium that the first user is riding on progresses. An illustritive example of the curated content provided to the user device being updated based on changing features (extracted from second contextual data) is detailed elsewhere herein, e.g., see operations 218-230.

Various operations described below detail a third portion of method 200 that includes collaborative filtering and recommendation systems in mobile generative AI. For example, operation 210 includes collaboratively filtering-out a first portion of the curated user device content based on a second user, e.g., based on data about the second user which may include any type of data or combination of data types disclosed herein, estimation based on observed behaviors of the second user, user device content previously created for a user device of the second user, a comparison between characteristics of and/or information about the first and second user, etc. It should be noted that the second user is a different user than the first user. In other words, at a relatively high level, this portion of method 200 includes suggesting relevant content to individuals based on similarities with other passengers or past preferences by analyzing user interactions and preferences within the collective environment.

A technical effect of filtering-out the first portion of the curated user device content based on the second user includes reducing an amount of the user device content that is processed, transmitted and offered to user devices. More specifically, a technical effect of using various operations of method 200 include ensuing that a sufficient but not relatively extensive amount of user device content is curated and provided to a user device. At least some curated device content (the first portion of the curated user device content) is filtered-out of the curated user device content to ensure this amount of user device content. As a result of this filtering, network traffic potential and user device processing that would otherwise be consumed processing the first portion of the curated user device content is preserved.

In some approaches, in order to determine what data to filter from the curated user device content to filter out, e.g., the first portion of the curated user device content, one or more operations may be performed to compare the first user with the second user. For example, monitoring techniques may be performed to collect data on user interactions, which, in some approaches, may include content consumption patterns, ratings, likes, dislikes, etc. In some other approaches, this monitoring may additionally and/or alternatively include techniques that are configured to compile additional behavioral signals such as viewing duration, pause and skip behaviors, and other relevant user actions that provide deeper insight into user preferences. This user data preferably includes at least some user data associated with the first user and at least some user data associated with the second user. Various techniques for analyzing this user data in order to identify the first portion of the user data and/or a second portion of the user data that is ultimately provided to a user device of the first user are detailed in various steps of the third portion of method 200 described below.

A first step of the third portion of method 200 includes calculating user similarities. In some approaches, these calculations may be caused to be performed by issuing an instruction to a predetermined engine that is configured to consume the user data and then apply algorithms such as cosine similarity, Pearson correlation coefficient, advanced matrix factorization techniques, etc., to measure the degree of similarity between the users based on interaction data of the different users. This degree of similarity may be output by the engine. This step may additionally and/or alternatively include applying a rule-based inference combined with machine learning algorithms to classify and group users with similar behaviors and preferences into clusters to streamline a determination of which data to filter out and which data to provide to the user device of the first user.

In one illustritive approach, the second user is a user that is determined to have previously experienced environmental conditions of the extracted features while using a second user device. Furthermore, in some approaches, the second user may be determined based on one of the algorithm based techniques described above (such as based on cosine similarity) to have preferences with at least a predetermined degree of similarity with the preferences of the first user. This way, in some approaches, user content that has proven to be favorable (offered and selected) to a user with preferences with at least the predetermined degree of similarity with the preferences of the first user may be identified and excluded from the filtering.

Use of cosine similarity in the determination that the second user has previously experienced the environmental conditions of the extracted features while using a second user device has a technical effect of sourcing previously performed determinations for reducing an amount of processing that is involved in performing further determinations. This preserves processing resources of a processing device (such as a computer) that is performing operations of method 200.

A second step of the third portion of method 200 includes training a model. More specifically, in some approaches, a rule-based inference may be applied to choose optimal machine learning algorithms that can perform efficiently in on-demand, local inference scenarios, particularly suitable for mobile environments where computing power may be limited. Accordingly, method 200 includes applying rule-based inferencing to identify a first machine learning algorithm. The identified algorithm may, in some approaches, be used to train models using the collected data to ensure that the models are capable of recognizing and reacting to nuanced user preferences and subtle shifts in content engagement. More specifically, in continuation of the example above, method 200 may include causing the first machine learning algorithm to train a model to use training contextual data to extract features from the training contextual data. In some approaches, the model may be an AI model that is trained using a predetermined set of contextual data. For example, in some approaches, various of the operations noted above may be deployed in a trained state of a trained AI model. Training of the AI model, in some approaches, may be performed by applying a predetermined training data set to learn how to perform the extractions detailed above. Initial training may include reward feedback that may, in some approaches, be implemented using a subject matter expert (SME) that generally understands whether an initial extraction has been performed. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 200 may be performed.

Method 200, in some approaches, includes causing the trained model to determine the preferences of the first user, e.g., see operation 206. These preferences may be determined in order to perform a third step of the third portion of method 200, which includes generating a personalized recommendation that can be used to collaboratively filter-out the first portion of the curated user device content based on the second user. In order to generate the personalized recommendation, a rule-based inference and/or large generative model may be caused to implement a recommendation engine that utilizes the trained model to generate and provide an indication of the second portion of the curated user device content, e.g., based on user similarities and historical data. In some approaches, a rule-based inference may be applied to verify and adjust recommendations in real-time as new data is collected, maintaining relevance and engagement.

A technical effect of causing a machine learning algorithm to train a model used to determine the preferences of the first user includes mitigation of processing delays and errors in that would otherwise be introduced in the process of a human attempting to determine such preferences.

On-demand model adaptation is enabled in a fourth step of the third portion of method 200. This step includes utilizing local generative AI facilities to perform on-demand inferencing, allowing for swift response times and reduced reliance on cloud-based resources. Furthermore, a rule-based inference may be applied to assess performance and regularly update models based on ongoing user interactions and environmental changes to ensure continuous improvement in an accuracy of user content that is provided to the user device of the first user.

A fifth step of the third portion of method 200 may be performed to enable multi-user engagement and adaptation. This step may include applying a rule-based inference upon collected data sets to assess collective preferences of all users within the mobile environment to enhance the communal experience, particularly in shared spaces. An algorithm may be implemented to adapt user content delivery strategies to match the dynamic context of mobile environments, such as adjusting for group viewing situations or individual consumption during travel. In other words, the portion and/or type of curated content that survives the filtering may change dynamically as the mobile environments in which users consume user data change.

With continued reference to method 200, the models used in various approaches described herein may be refined, in some approaches, using this feedback. For example, operation 214 includes obtaining feedback from the user device of the first user, where the feedback includes selections made by the first user on the user device. These selections may, in some approaches, detail an accuracy that the second portion of the curated user device content have with respect to the preferences of the first user. For example, in at least some of these approaches, the selections may indicate whether the user is satisfied with the user content, or whether the user found that the selections were inaccurate to what the user wants to consume. In some other approaches, the selections themselves may indicate a degree of such satisfaction based on metrics associated with the selections. For example, a selection made followed by at least a predetermined period of the user not selecting to switch to other available user content may be correlated with user satisfaction, while in contrast, a selection made followed by the user selecting to switch to other available user content within a predetermined amount of time may be correlated with user dissatisfaction.

The feedback may additionally and/or alternatively further detail whether anticipated environmental conditions were in fact accurate and whether selections made by the first user in situations in which those environmental conditions were present. This type of feedback may be used to determine whether models are sufficiently accurate or should be updated to increase accuracy. For example, in some approaches, the feedback may be used to update the trained model to refine an extraction accuracy of the trained model, e.g., see operation 216. This update may in some approaches be in the form of reward based feedback. In some other approaches, the feedback may be incorporated into test cases of a training set of data used to train and/or refine the models and/or other models.

Using feedback to refine an accuracy of the trained model has a technical effect of iteratively improving the portions of data that are ultimately provided to user devices for users to view. Furthermore, by refining an accuracy of the trained model, curated user device content that would otherwise be unnecessarily processed is not transmitted to and processed by the user device. This preserves processing resources and ultimately reduces an amount of computations that are performed in each iteration of method 200.

The potentially iterative nature of method 200 which may, in some approaches, be followed in order to ensure accurate user device content and/or dynamically curate the user device content according to changing conditions is detailed in various operations below that are based on obtained second contextual data.

Operation 218 includes obtaining second contextual data collected by the plurality of sensors. Techniques described elsewhere herein for obtaining the first contextual data may be modified in order to obtain the second contextual data. Operation 220 includes performing the machine learning techniques to extract features from the second contextual data. The features extracted from the second contextual data may, in some approaches, detail a change in user preferences. In some other approaches, the features extracted from the second contextual data may, in some approaches, additionally and/or alternatively detail second environmental conditions that are different than the first environmental conditions. To monitor these differences, a determination may be made as to whether such differences are present in different obtained contextual data. For example, decision 222 includes determining whether the second environmental conditions have at least a predetermined degree of similarity with the first environmental conditions. Comparison engines and/or techniques that would become apparent to one of ordinary skill in the art after reading the descriptions herein may be used to perform such a determination.

In response to a determination that the second environmental conditions have at least a predetermined degree of similarity with the first environmental conditions, e.g., as illustrated by the “YES” logical path of decision 222, method 200 optionally ends, e.g., see operation 224. By ending, in some approaches, the second portion of the curated user device content continues to be caused to be provided to the user device of the first user. In contrast, in response to a determination that the second environmental conditions have less than the predetermined degree of similarity with the first environmental conditions, e.g., as illustrated by the “NO” logical path of decision 222, updated user device content may be curated based on the second environmental conditions and/or the preferences of first user, e.g., see operation 226.

Operation 228 includes collaboratively filtering-out a first portion of the updated curated user device content based on the second user to reduce an amount of the amount of user device content that is processed, transmitted and offered to user device(s). Techniques similar to those relied on elsewhere herein for filtering-out the first portion of the curated user device content may be modified to perform filtering on the updated curated user device content. Operation 230 includes causing a second portion of the updated curated user device content (a remainder that was not filtered out during the collaborative filtering) to be provided to the user device of the first user.

A technical effect of using collaborative filtering and application contextual embedding models includes reducing an amount of the user device content that is processed by referencing determinations previously performed for other users. Furthermore, a technical effect of obtaining additional contextual data includes ensuring that as conditions of an environment in which the user device is located changes, the curated user device content also changes to reflect the changing conditions.

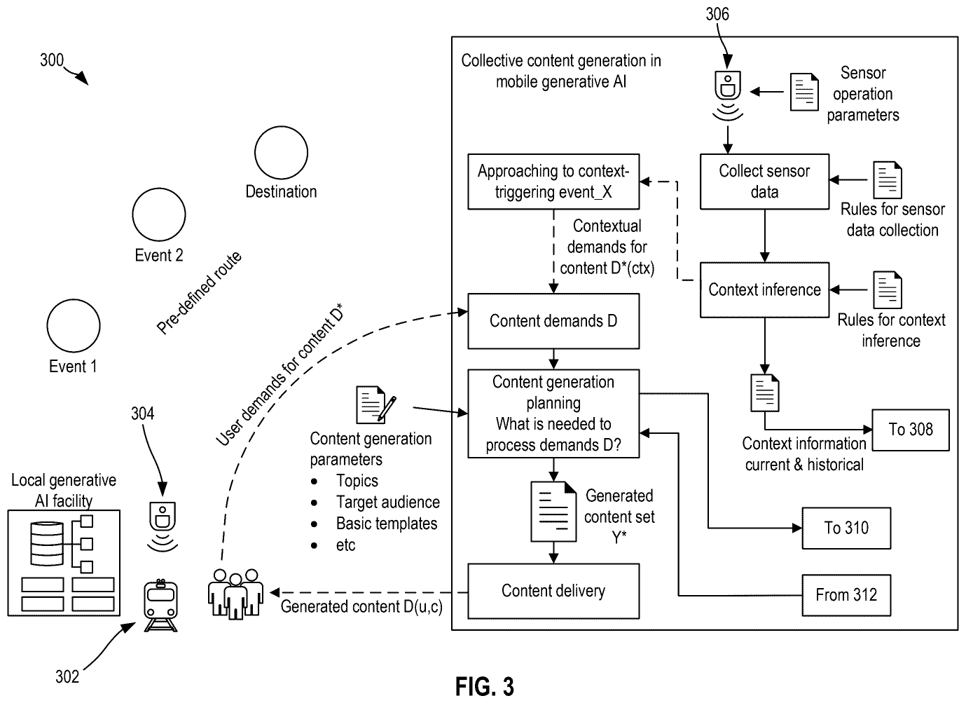

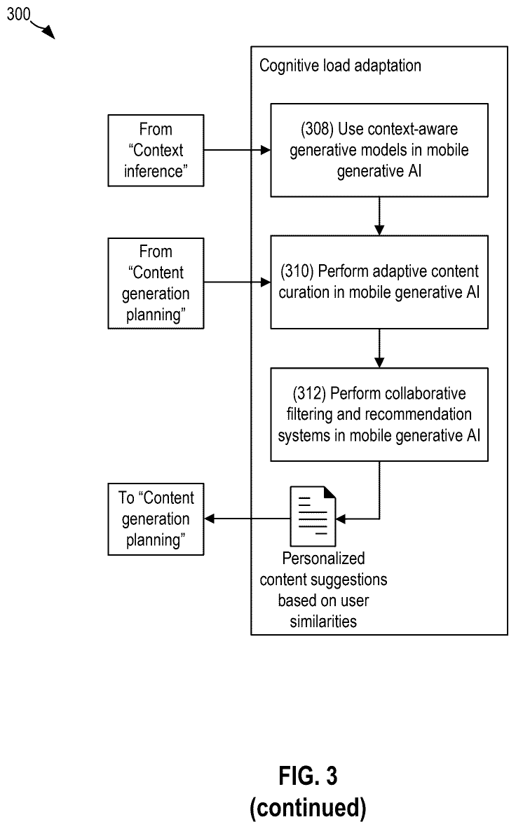

FIG. 3 depicts a system 300, in accordance with one approach. As an option, the present system 300 may be implemented in conjunction with features from any other approach listed herein, such as those described with reference to the other FIGS. Of course, however, such system 300 and others presented herein may be used in various applications and/or in permutations which may or may not be specifically described in the illustrative approaches listed herein. Further, the system 300 presented herein may be used in any desired environment.

It should be prefaced that system 300 includes infrastructure that may be used to perform operations described herein, e.g., such as one or more operations of method 200. For example, system 300 may be an operating environment that, in some approaches, includes a mobile generative AI environment equipped with a local generative AI facility able to run an on-demand local inference of large AI models.

In some approaches, a local generative AI facility may be onboarded in a transport medium, e.g., see vehicle 302. The local generative AI facility may be responsible for generating content “Y” based on local users or application demands, e.g., “set X”, which may include embarked computing clusters, repository of base methods, local orchestration strategies, etc. In one approach, a use case of the local generative AI facility may include a multi-user moving environment with onboard computing capabilities. Context-aware generative models may be used to analyze the sensor data in real time to understand the current environment and passenger preference in the process of providing on demand content to the user devices of passengers during a journey.

In some approaches, preconfigured sets of models are loaded to the local environment, e.g., see local generative AI facility, which may be able to process certain requests R*(D) related to demand D, e.g., see “User demands for content D*” and “Contextual demands for content D*(ctx)” which may be driven by predetermined events (see “Approaching to context-triggering event_X”). In some approaches, this processing includes dynamically loading or unloading AI models based on a new or changing demand within these requests.

In some approaches, contextual information is obtained within a collective environment of the system 300 which may include collective transportation vehicles e.g. an airplane, a bus, a train, etc., which may be equipped with infrastructure associated with the local generative AI facility, sensors 304 and 306, and may provide contextualized content as a service for a multi-user environment. This information may additionally and/or alternatively be used to connect to a hybrid cloud generative AI facility, which may be distributed upon 5G-MEC nodes and cloud computing to provide remote generative AI facilities for on-demand inferencing from the mobile generative AI environment.

In some approaches, the sensors may capture individual and collective information, track passenger movements along a predefined route on which events occur (see Event1, Event2 and Event3), and monitor environmental conditions. Operations performed within system 300 revolve around leveraging rule-based inference and large AI models to infer passenger preferences and environmental context from the obtained contextual data, thereby enabling dynamic adaptation of content generation strategies in real-time within mobile generative AI environments.

Although some user device content may be generated within the collective content generation in mobile generative AI portion of the system 300, in some preferred approaches, context information (current and historical) may be provided to an engine configured to perform operations to curate accurate user device content, e.g., see operations 308. For example, collected sensor data and context inferences (which may be based on sensor operation parameters, rules for sensor data collection and/or rules for context inferencing) may be provided to engine(s) of a cognitive load adaptation portion of infrastructure of system 300. A first portion of operations performed within the cognitive load adaptation portion of infrastructure of system 300 are based on context-aware generative models in mobile generative AI. These operations apply a combination of rule-based inferences and ML algorithms to continuously learn and refine user preferences and environmental factors and dynamically adapt content generation based on individual user preferences, historical data, and real-time context. For instance, in response to a determination that a passenger frequently selects comedy content during morning commutes, similar content is prioritized at similar times for providing to a user device of the user. Additionally, these operations adapt content based on factors such as network connectivity, vehicle speed, and passenger demographics, ensuring optimal content delivery regardless of changing conditions. It should be noted similar operations are described in the steps of the first portion of method 200.

Thereafter, operations (e.g., see operations 310) may be performed for enabling adaptive content curation in mobile generative AI (note that similar operations are described in the steps of the second portion of method 200). These operations may, in some approaches, include curating content based on both individual preferences and collective trends observed from sensor data. This ensures personalized recommendations while also catering to broader passenger interests. Individual passenger interactions are analyzed by the system by tracking content consumption patterns, explicit feedback, and implicit signals such as dwell time or skipping behavior.

Thereafter, operations (e.g., see operations 312) may be performed for collaborative filtering and recommendation systems in mobile generative AI (note that similar operations are described in the steps of the third portion of method 200). Determined relevant content may be suggested to individuals based on similarities with other passengers or past preferences by analyzing user interactions and preferences within the collective environment that a user device of a user and/or the user is located in.

An output of these operations (e.g., see “Personalized content suggestions based on user similarities”) includes user device content that is not filtered-out of curated content. This output is incorporated into content, e.g., see “Generated content set Y*”, that is delivered to a user device of one or more users, e.g., see content delivery and “Generated content D(u,c)”.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
obtaining first contextual data collected by a plurality of sensors;
performing machine learning techniques to extract features from the first contextual data;
curate user device content based on the extracted features and preferences of a first user;
collaboratively filtering-out a first portion of the curated user device content based on a second user; and
causing a second portion of the curated user device content to be provided to a user device of the first user.

2. The method of claim 1, wherein the sensors include at least some mobile sensors wherein the features extracted from the first contextual data are selected from the group consisting of: passenger location, movement patterns, ambient noise levels, vehicle speed, and environmental conditions.

3. The method of claim 2, wherein the environmental conditions are selected from the group consisting of: a current ambient temperature of a transportation medium that the first user is located on, a current noise level that the first user is subjected to while located on the transportation medium, a current type of scenery view that the first user has while on the transportation medium, and a strength of network signal that the user device of the first user is connected to.

4. The method of claim 1, wherein the features extracted from the first contextual data include first environmental conditions, wherein the machine learning techniques performed include application of collaborative filtering and application of contextual embedding models, and further comprising:
obtaining second contextual data collected by the plurality of sensors;
performing the machine learning techniques to extract features from the second contextual data, wherein the features extracted from the second contextual data detail second environmental conditions that are different than the first environmental conditions; and
in response to a determination that the second environmental conditions have less than a predetermined degree of similarity with the first environmental conditions:
curating updated user device content based on the second environmental conditions,
collaboratively filtering-out a first portion of the updated curated user device content, and
causing a second portion of the updated curated user device content to be provided to the user device of the first user.

5. The method of claim 1, wherein the curating user device content based on the extracted features and preferences of the first user comprises:
applying a rule-based inference to analyze the extracted features to identify patterns that represent preferences of the first user and preferences of the second user,
parsing available content libraries to identify the user device content, wherein the user device content has characteristics that match portions of the identified patterns, and
ranking portions of the user device content based on the preferences of the first user, wherein the collaborative filtering incorporates the rankings.

6. The method of claim 1, wherein the second user is a user that is determined to have previously experienced environmental conditions of the extracted features while using a second user device, wherein the second user is determined, based on cosine similarity to have preferences with at least a predetermined degree of similarity with the preferences of the first user.

7. The method of claim 6, further comprising:
applying rule-based inferencing to identify a first machine learning algorithm;
causing the first machine learning algorithm to train a model to use training contextual data to extract features from the training contextual data; and
causing the trained model to determine the preferences of the first user.

8. The method of claim 7, wherein the collaboratively filtering-out the first portion of the curated user device content based on the second user comprises:
causing a rule-based inference and/or large generative model to implement a recommendation engine that utilizes the trained model to generates and provides an indication of the second portion of the curated user device content.

9. The method of claim 8, further comprising:
obtaining feedback from the user device of the first user, wherein the feedback includes selections made by the first user on the user device; and
using the feedback to update the trained model to refine an extraction accuracy of the trained model.

10. A computer program product comprising:
one or more computer-readable storage media; and
program instructions stored on the one or more storage media to perform operations comprising:
obtaining first contextual data collected by a plurality of sensors;
performing machine learning techniques to extract features from the first contextual data;
curate user device content based on the extracted features and preferences of a first user;
collaboratively filtering-out a first portion of the curated user device content based on a second user; and
causing a second portion of the curated user device content to be provided to a user device of the first user.

11. The computer program product of claim 10, wherein the sensors include at least some mobile sensors wherein the features extracted from the first contextual data are selected from the group consisting of: passenger location, movement patterns, ambient noise levels, vehicle speed, and environmental conditions.

12. The computer program product of claim 11, wherein the environmental conditions are selected from the group consisting of: a current ambient temperature of a transportation medium that the first user is located on, a current noise level that the first user is subjected to while located on the transportation medium, a current type of scenery view that the first user has while on the transportation medium, and a strength of network signal that the user device of the first user is connected to.

13. The computer program product of claim 10, wherein the features extracted from the first contextual data include first environmental conditions, wherein the machine learning techniques performed include application of collaborative filtering and application of contextual embedding models, and wherein the operations further comprise:
obtaining second contextual data collected by the plurality of sensors;
performing the machine learning techniques to extract features from the second contextual data, wherein the features extracted from the second contextual data detail second environmental conditions that are different than the first environmental conditions; and
in response to a determination that the second environmental conditions have less than a predetermined degree of similarity with the first environmental conditions:
curating updated user device content based on the second environmental conditions,
collaboratively filtering-out a first portion of the updated curated user device content, and
causing a second portion of the updated curated user device content to be provided to the user device of the first user.

14. The computer program product of claim 10, wherein the curating user device content based on the extracted features and preferences of the first user comprises:
applying a rule-based inference to analyze the extracted features to identify patterns that represent preferences of the first user and preferences of the second user,
parsing available content libraries to identify the user device content, wherein the user device content has characteristics that match portions of the identified patterns, and
ranking portions of the user device content based on the preferences of the first user, wherein the collaborative filtering incorporates the rankings.

15. The computer program product of claim 10, wherein the second user is a user that is determined to have previously experienced environmental conditions of the extracted features while using a second user device, wherein the second user is determined, based on cosine similarity to have preferences with at least a predetermined degree of similarity with the preferences of the first user.

16. The computer program product of claim 15, wherein the operations further comprise:
applying rule-based inferencing to identify a first machine learning algorithm;
causing the first machine learning algorithm to train a model to use training contextual data to extract features from the training contextual data; and
causing the trained model to determine the preferences of the first user.

17. The computer program product of claim 16, wherein the collaboratively filtering-out the first portion of the curated user device content based on the second user comprises:
causing a rule-based inference and/or large generative model to implement a recommendation engine that utilizes the trained model to generates and provides an indication of the second portion of the curated user device content.

18. The computer program product of claim 17, wherein the operations further comprise:
obtaining feedback from the user device of the first user, wherein the feedback includes selections made by the first user on the user device; and
using the feedback to update the trained model to refine an extraction accuracy of the trained model.

19. A computer system comprising:
a processor set;
one or more computer-readable storage media; and
program instructions stored on the one or more storage media to cause the processor set to perform operations comprising:
obtaining first contextual data collected by a plurality of sensors;
performing machine learning techniques to extract features from the first contextual data;
curate user device content based on the extracted features and preferences of a first user;
collaboratively filtering-out a first portion of the curated user device content based on a second user; and
causing a second portion of the curated user device content to be provided to a user device of the first user.

20. The computer system of claim 19, wherein the sensors include at least some mobile sensors wherein the features extracted from the first contextual data are selected from the group consisting of: passenger location, movement patterns, ambient noise levels, vehicle speed, and environmental conditions.
